(19) United States
(12) Patent Application Publication
(10) Pub. No.: US 2025/0091386 A1
(43) Pub. Date: Mar. 20, 2025

(54) WHEEL HUB SYSTEM CAPABLE OF WHEEL SIDE GREASING AND APPLICATION WITHOUT DISASSEMBLY

(71) Applicant: Kryptonite Products, Inc., Sheridan, WY (US)

(72) Inventor: Michael Durand, Gardnerville, NV (US)

(21) Appl. No.: 18/886,796

(22) Filed: Sep. 16, 2024

Related U.S. Application Data
(60) Provisional application No. 63/583,150, filed on Sep. 15, 2023.

(51) Int. Cl. B60B 27/02; B60B 27/00; B62D 7/18; F16C 35/06

(52) U.S. Cl. CPC B60B 27/02; B60B 27/0052; B60B 27/0078; F16C 35/06; B60B 2900/113; B60B 2900/541; B60B 2900/561; B62D 7/18; F16C 2326/02

(57) ABSTRACT

A component for a wheel hub assembly and an axle assembly comprising: a volume; a channel, the channel extending from a first side of the wheel hub to the volume; a first port, placing the channel in fluid communication with the volume; and a second port, placing the channel in fluid communication with a surface of the first side; wherein the wheel hub houses a bearing via the volume, and lubricant is applied to the volume and the bearing via the channel while the wheel hub remains assembled and physically coupled to other components of a vehicle.

### CROSS-REFERENCE TO RELATED APPLICATION

This application claims priority to U.S. Provisional Application No. 63/583,150, entitled “WHEEL HUB SYSTEM CAPABLE OF WHEEL SIDE GREASING AND APPLICATION WITHOUT DISASSEMBLY,” and filed Sep. 15, 2023, the entire contents of which are hereby incorporated by reference for all purposes.

### TECHNICAL FIELD

The present disclosure relates generally to a wheel hub with a channel that is internal to the material of the hub. The channel fluidly couples to a first port on the wheel side and a second port on a grease valley that may support a bearing internal to the hub.

### BACKGROUND AND SUMMARY

A vehicle, such as an on highway or off-highway vehicle, may have a plurality of axles and wheels. The axles of the vehicle may comprise axle shafts rollingly coupled and/or drivingly coupled to the wheels. An axle shaft may be drivingly coupled and at least rollingly coupled to a wheel via a wheel hub assembly. There may be a plurality of wheel hub assemblies, with a wheel hub rollingly coupled to each axle shaft and a wheel complementary to the axle shafts. The wheel hub assembly may comprise a brake component and a hub component. The hub component may fasten to the wheels via fasteners and fastening structures, wherein the fastening structures serve as mounts for the fasteners. The hub component may comprise a housing that may house a single or plurality of bearings. The bearing or bearings may support and be located about components of an axle shaft and/or feature of the housing. The bearing or bearings may be lubricated via lubricant, such as grease. One of the bearings may be housed in a groove or a cavity on the axle side of the hub. Likewise, the wheel hub assembly may include a knuckle or a spindle the axle shaft or a shaft drivingly coupled to the axle shaft may extend through. The shaft extending through the knuckle or spindle may be supported by another bearing, where the other bearing is housed via the knuckle or spindle. The other bearing may be referred to as the other bearing herein.

To lubricate a bearing enclosed and housed within the wheel hub, the wheel hub and by extension the wheel hub assembly may be disassembled. If the bearing is closest to the wheel side of the wheel hub, the wheel hub assembly may have to be removed from the vehicle, the hub assembly may have to be disassembled, and the wheel hub may have to be disassembled. Once the wheel hub is disassembled, lubricant may be applied the groove or cavity and the bearing housed within via a grease dispensing and application tool or another lubricant application tool. Similarly, a knuckle or spindle and the wheel hub assembly therearound may have to be disassembled to apply lubricant to a hole or another volume housing the other bearing. Disassembly of components of the wheel hub assembly may include removal of the shaft from the knuckle or spindle supported by the other bearing. Such a process of lubricating may have a substantial amount of components of a hub assembly and regions about the hub assembly disassembled. A substantial amount of time may be used to disassemble and re-assemble the aforementioned components compared to the amount of time used by other steps to supply lubricant to the bearings.

The inventors herein have recognized these and other issues with such systems.

For a first example, the component may be a wheel hub. Grease and/or other lubricant may therein be added via the second port to the wheel hub and fed through the channel and first port to lubricate the bearing without disassembly of the wheel hub or disassembly of the wheel hub from the wheel hub assembly.

For a second example, the component may be a bearing carrier such as the knuckle or the spindle of a wheel hub assembly. The knuckle and the spindle may be a steering knuckle and a steering spindle, respectively, for the wheel hub assembly. Grease and/or other lubricant may therein be added via the second port to the bearing carrier and fed through the channel and first port to lubricate the bearing without disassembly of the bearing carrier or disassembly of the bearing carrier from the wheel hub assembly.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings, in which:

FIG. 1 shows an example schematic of a vehicle which may include wheel hubs of the present disclosure.

FIG. 2 shows a first view of a wheel hub of prior art.

FIG. 3 shows a second view of a wheel hub assembly of the present disclosure.

FIG. 4 shows a third view that is a side view of the wheel hub of the present disclosure isolated from the wheel hub assembly.

FIG. 5 shows a fourth view that is a side view of the wheel hub of the present disclosure.

FIG. 6 shows a fifth view that is a bottom view of the wheel hub of the present disclosure.

FIG. 7 shows a sixth view that is a sectional view of the wheel hub of the present disclosure.

FIG. 8. shows a seventh view of an area of the wheel hub of the present disclosure.

FIG. 9 shows an eighth view that is a side view of a bearing carrier of the present disclosure.

FIG. 10 shows a ninth view that is a side view of the bearing carrier of the present disclosure.

FIG. 11 shows a tenth view that is a sectional view of the bearing carrier of the present disclosure.

### DETAILED DESCRIPTION

The system and components are provided for a wheel hub assembly and wheel hub. The wheel hub of the present disclosure may be a part of a wheel hub assembly comprising a braking components, such as a brake rotor, a knuckle, and a shaft. The wheel hub comprises a wheel side and an axle side. When the wheel hub is mounted to an axle and wheel, the wheel side may be positioned closest to the wheel and the axle side may be positioned closest to a shaft of the axle. The wheel side may face and or have surface sharing contact with the wheel or be incorporated into the wheel. The axle side may face and be rotatably coupled to a component of the axle such as the axle shaft.

The wheel hub may comprise a platform section about a mouth to a receiving hole for a shaft. The platform section may be formed on the wheel side of the wheel hub. The wheel hub comprises a plurality of mounting structures positioned radially about the platform section and are contiguous with the wheel hub. The mounting structures may be complementary to a plurality of fasteners. The fasteners may fasten the wheel hub to a wheel. The wheel hub may also comprise a first groove about a socket on the axle side. The socket may be about the receiving hole for a shaft. The first groove may house a bearing. A channel may fluidly couple the groove to a second port on a surface of the platform section. The channel may extend through the material of the wheel hub. The channel may allow for grease or another lubricant to be passed through, such that the lubricant of the journal section, first groove, and bearing may be replenished without disassembly of the wheel hub or the wheel hub assembly.

The first groove may comprise a plurality of valleys, that may be referred to herein alternatively as grease valleys. There may be a first valley and a second valley. The groove, first valley, and second valley may be positioned about a journal section of a socket. The socket may be positioned about and house a shaft, such as an axle shaft or alternatively a shaft driven by the axle shaft. The shaft may be drivingly coupled to a wheel via the wheel hub. For example, the shaft may rigidly couple to the wheel via the wheel hub.

The bearing may be supported at least a valley, such as the first valley, of the first groove and a complementary shoulder to and comprised by the valley. The bearing may be positioned about the valley and the journal section of the socket.

Inset into the journal section and the valley may be a first port and a second groove complementary to the port, wherein the second groove may be in fluid communication with the port. The second groove may be positioned about the first port. The second port may be fluidly coupled to the first port via the channel. Lubricant may travel through the channel and first port from the second port, to be applied to the journal section and the aforementioned valley.

Additionally, the systems of the first port, the second port, and the channel may be used for other housing for a bearing besides the hub. For example, another bearing may be housed via a bearing carrier, wherein the bearing carrier is a knuckle or a spindle, such as a steering knuckle or steering spindle. The shaft that drivingly couples to the wheel via the wheel hub may extend through the bearing carrier and be supported by the other bearing housed therein. Grease and/or other lubricant may therein be added via the second port to the bearing carrier and fed through the channel and first port to lubricate the bearing without disassembly of the bearing carrier or disassembly of the bearing carrier from the wheel hub assembly. The bearing carrier may have a third port similar in function to the second port, a fourth port similar in function the first port, and a second channel similar in function to the channel. Lubricant may enter into the bearing carrier via the third port, and may travel through the second channel and the fourth port from the third port. The lubricant may exit the fourth port to lubricate the other bearing and a hole of the bearing carrier the other bearing is housed therein. The fourth port may be inset into a third groove extending radially from the hole and into an inner surface of the bearing carrier.

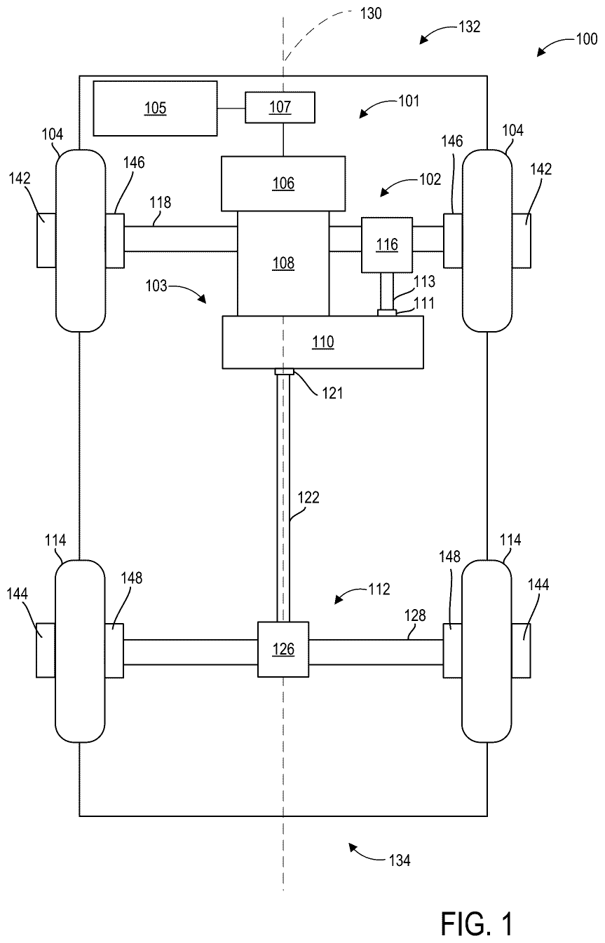

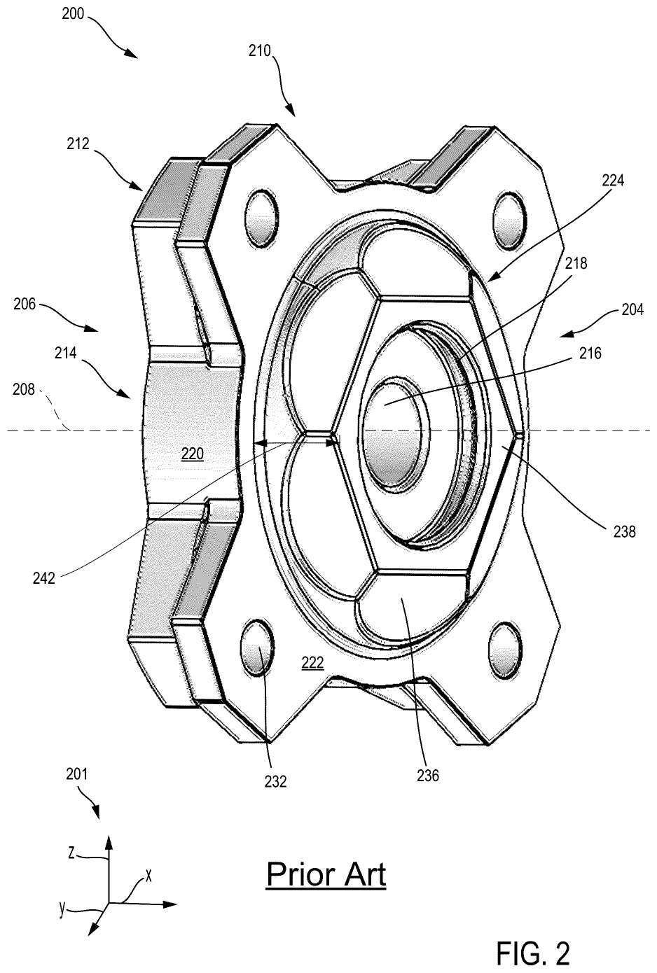

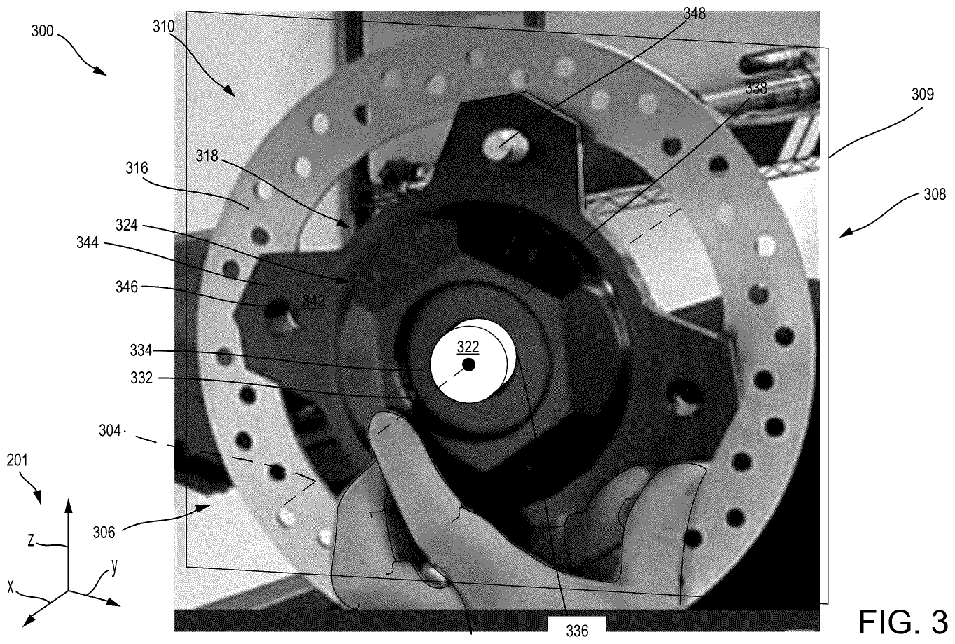

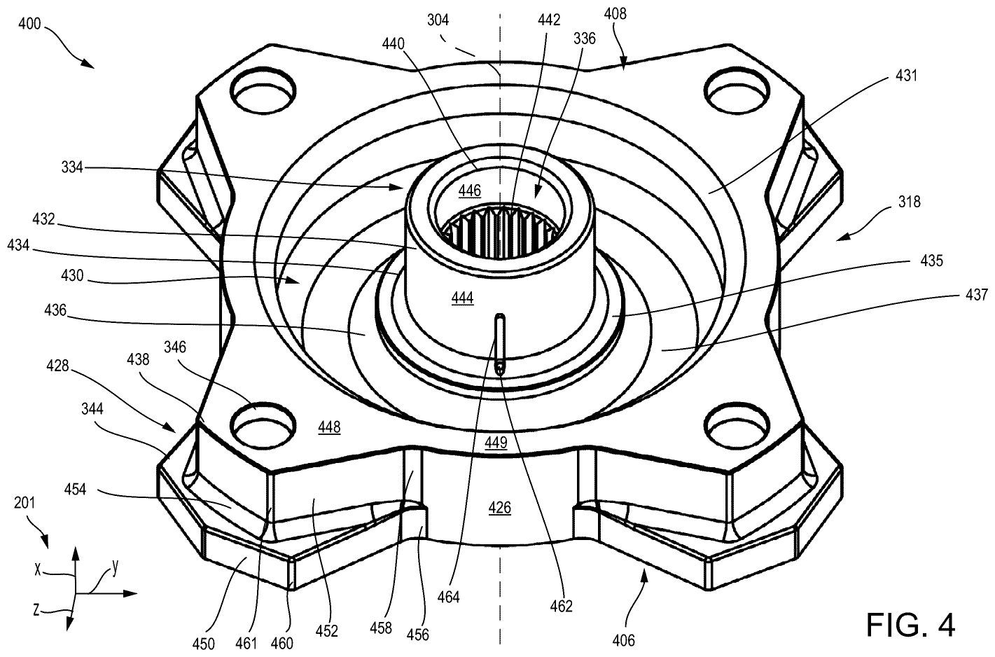

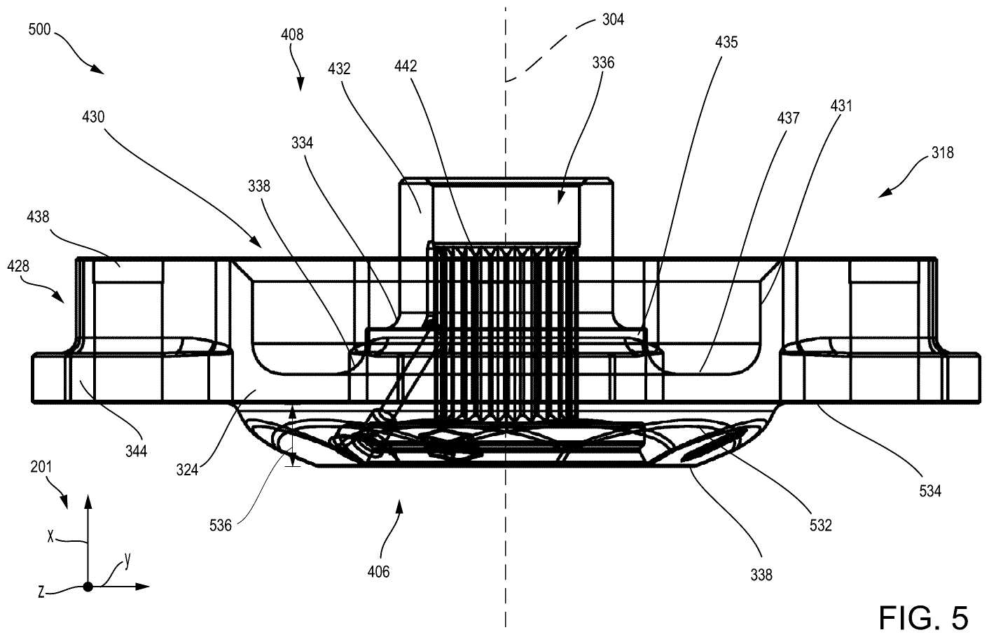

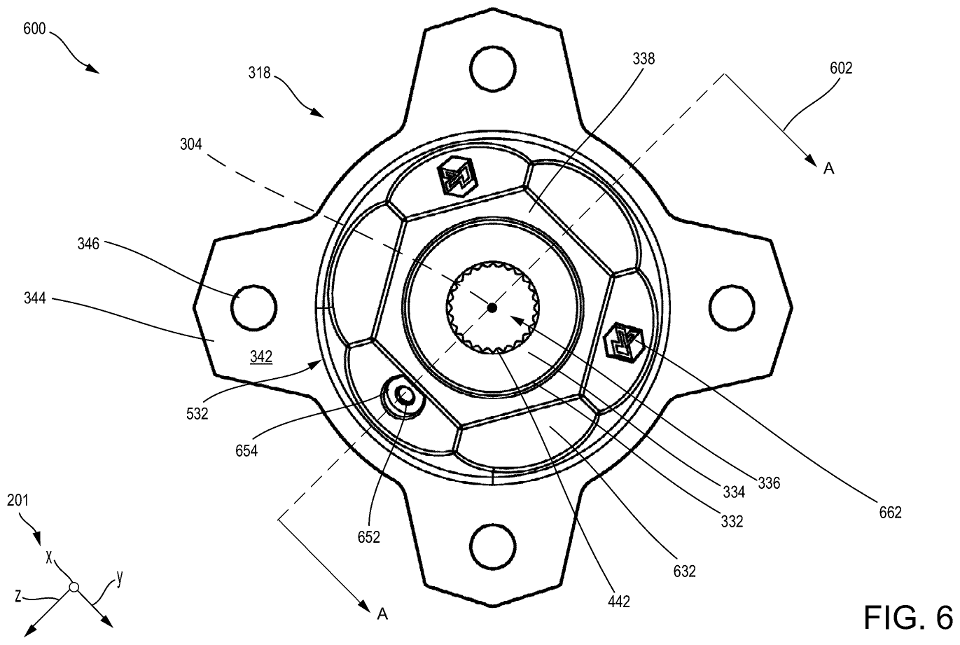

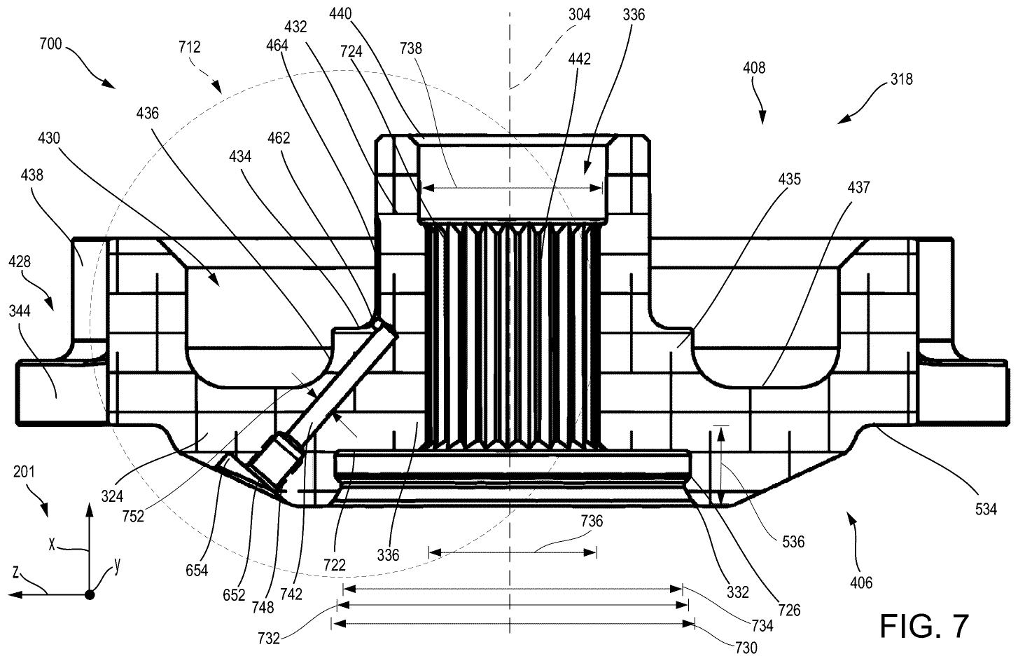

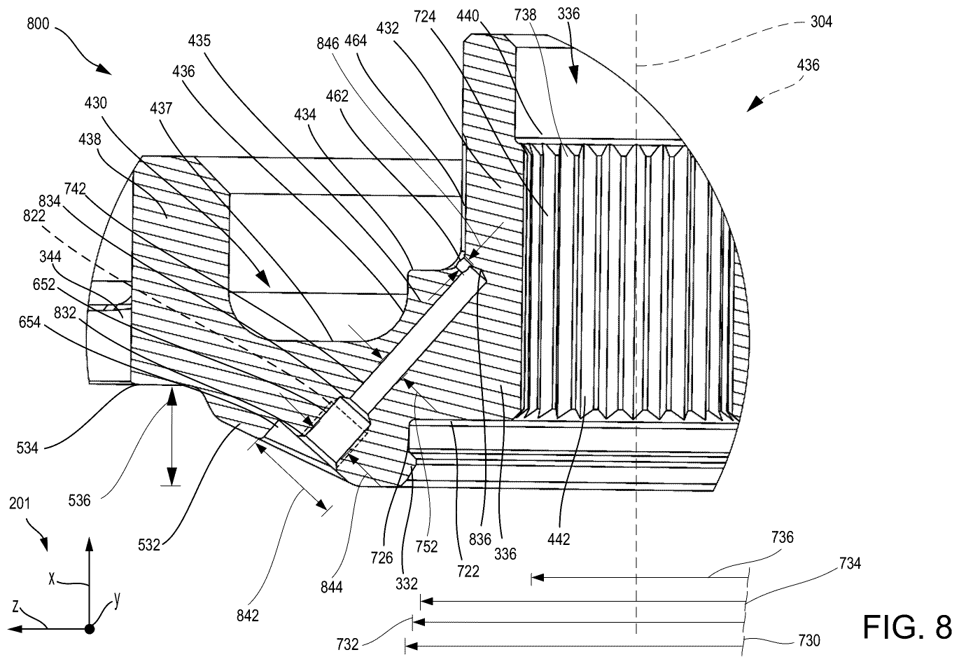

FIG. 1 shows an example schematic of a vehicle which may include wheel hubs of the present disclosure. FIG. 2 shows a first view of a wheel hub of prior art. FIG. 3 shows a second view of a wheel hub assembly of the present disclosure. FIG. 4 shows a third view that is a side view of the wheel hub of the present disclosure isolated from the wheel hub assembly. FIG. 5 shows a fourth view that is a side view of the wheel hub of the present disclosure. FIG. 6 is a fifth view that is a bottom view of the wheel hub of the present disclosure. FIG. 7 is a sixth view that is a sectional view of the wheel hub of the present disclosure. The sixth view of FIG. 7 shows a channel that fluidly couple a first port to a second port, such that lubricant may be delivered from the second port to the first port. FIG. 8. shows a seventh view of an area of the wheel hub of the present disclosure. The seventh view of FIG. 8 shows additional detail and features of the channel.

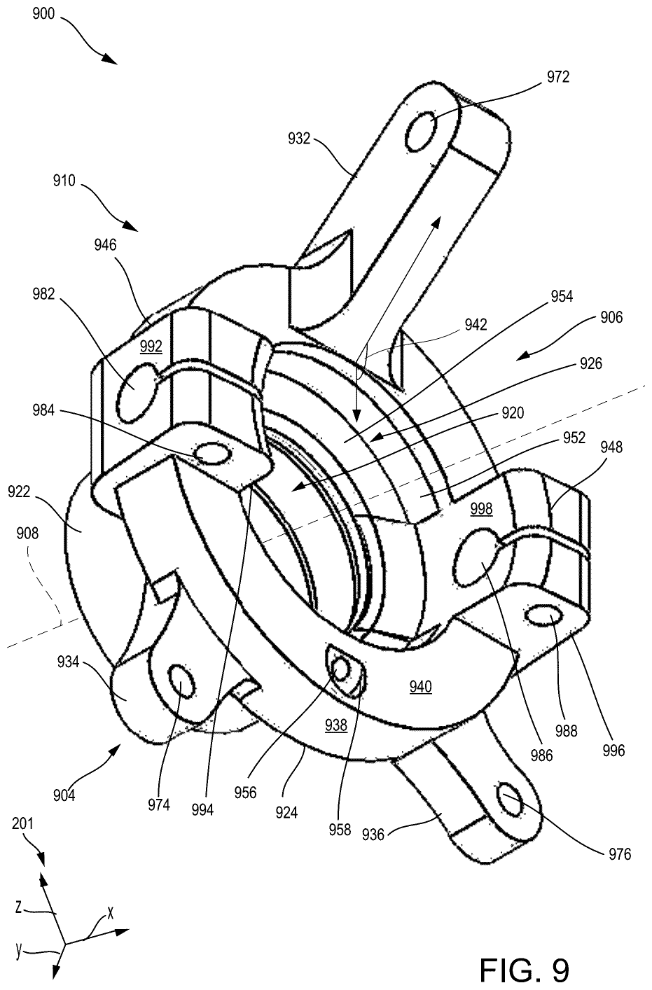

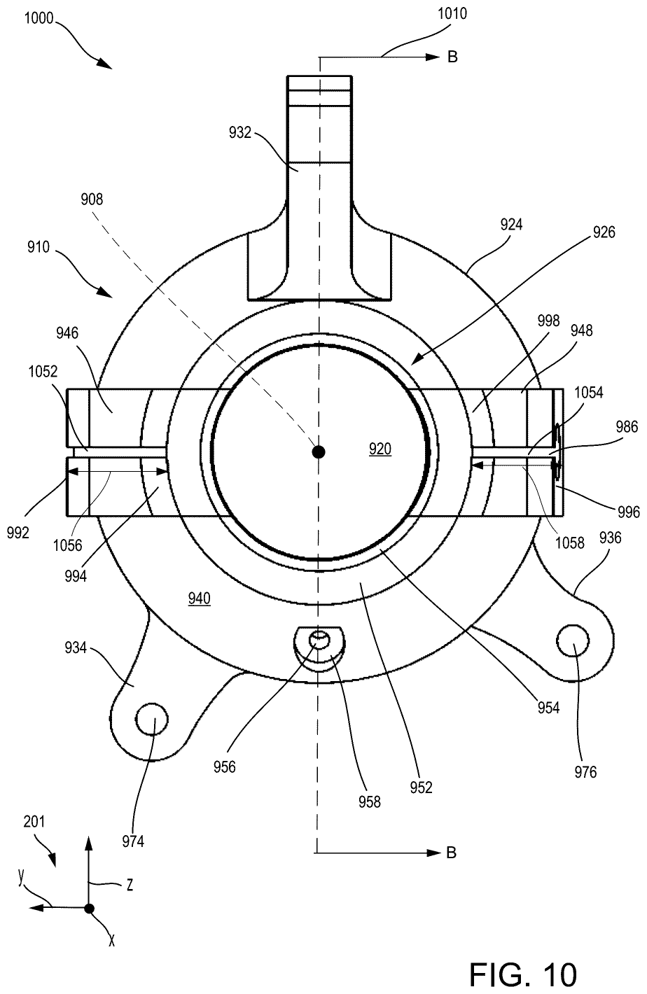

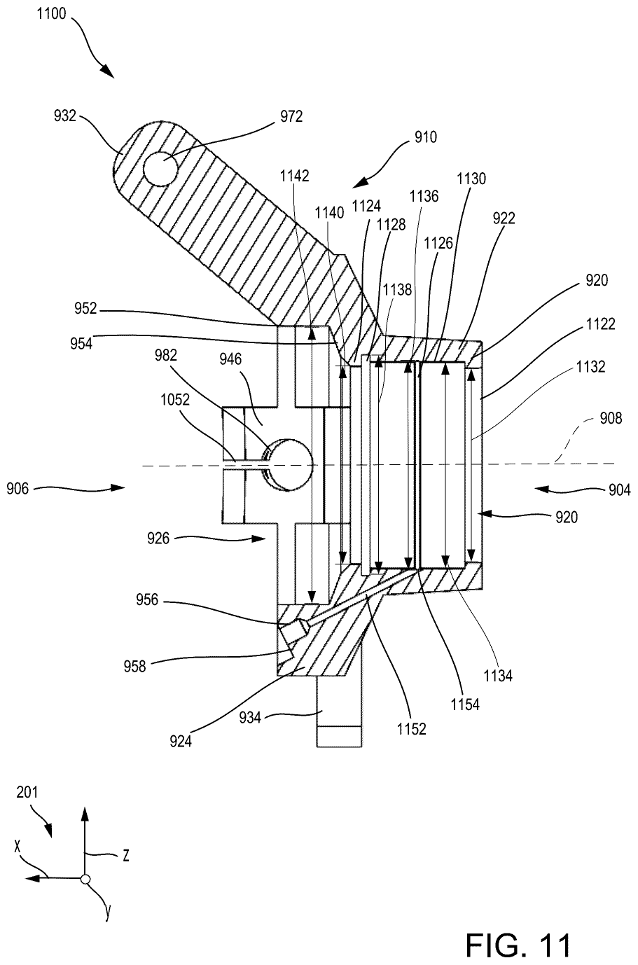

FIG. 9 shows an eighth view that is a side view of a bearing carrier of the present disclosure. The bearing carrier may have a third port allowing for lubricant to be transported to the inner surfaces of the bearing carrier. FIG. 10 shows a ninth view that is a side view of the bearing carrier of the present disclosure. The ninth view shows a line that may be used to take a sectional view of the bearing carrier. FIG. 11 shows a tenth view that is a sectional view of the bearing carrier of the present disclosure. The tenth view of FIG. 11 may be taken on the line of the ninth view in FIG. 10. The tenth view shows another channel that may transport lubricant from the third port to the inner surfaces and features of the bearing carrier.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

FIG. 1 show schematics of example configurations with relative positioning of the various components. Herein, when the motor system and/or housing of the motor system is positioned on level ground, vertical is shown with respect to gravity. FIGS. 2-11 are shown approximately to scale, although other relative dimensions may be used. As used herein, the terms “approximately” is construed to mean plus or minus five percent of the range unless otherwise specified.

Further, FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of the element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. Moreover, the components may be described as they relate to reference axes included in the drawings.

Turning now to FIG. 1, a vehicle 100 is shown comprising a powertrain 101 and a drivetrain 103. The vehicle 100 may have a front end 132 and a rear end 134, located on opposite sides of vehicle 100. Objects, components, and features of the vehicle 100 referred to as being located near the front may be closest to the front end 132 compared to the rear end 134. Objects, components, and features of the vehicle 100 referred to as being located near the rear may be closest to the rear end 134 compared to the front end 132. The powertrain 101 comprises a prime mover 106 and a transmission 108. The prime mover 106 may be an internal combustion engine (ICE) or an electric motor, for example, and is operated to provide rotary power to the transmission 108. The transmission 108 may be any type of transmission, such as a manual transmission, an automatic transmission, or a continuously variable transmission. The transmission 108 receives the rotary power produced by the prime mover 106 as an input and outputs rotary power to the drivetrain 103 in accordance with a selected gear or setting. Additionally, there may be other movers in the vehicle besides prime mover 106. If the prime mover 106 is an ICE there may be at least a second mover with an input to the transmission 108, wherein the second mover may be an electric machine such as an electric motor. In one example, if there are a single or plurality of second movers in addition to the prime mover 106, the vehicle 100 may be a hybrid vehicle, wherein there are multiple torque inputs to the transmission 108. The vehicle 100 may have a longitudinal axis 130. The powertrain 101 and drivetrain 103 may have a length parallel with the longitudinal axis 130.

The prime mover 106 may be powered via energy from an energy storage device 105. In one example, the energy storage device 105 is a battery configured to store electrical energy. However, it is to be appreciated that the energy storage device 105 may be non-limiting. For other examples, the energy storage device 105 may a device such as a single or plurality of fuel cells or capacitors, such as super capacitors. An inverter 107 may be arranged between the energy storage device 105 and the prime mover 106 and configured to adjust direct current (DC) to alternating current (AC). The inverter 107 may include a variety of components and circuitry with thermal demands that effect an efficiency of the inverter.

The vehicle 100 may be a commercial vehicle, light, medium, or heavy duty vehicle, a passenger vehicle, an off-highway vehicle, and/or sport utility vehicle. Additionally or alternatively, the vehicle 100 and/or one or more of its components may be in industrial, locomotive, military, agricultural, and/or aerospace applications. In one example, the vehicle 100 is an all-electric vehicle or a vehicle with all-electric modes of operation, such as a plug-in hybrid vehicle. As such, the prime mover 106 is an electric machine. In one example, the prime mover 106 is an electric motor/generator.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a rear-wheel drive, a front wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 122 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 122 (e.g., a rear driveshaft) transmits the rotary power from the transfer case 110 to a second differential 126 of the second axle assembly 112 to drive the second set of wheels 114. For example, the first differential 116 is drivingly coupled to a first set of axle shafts 118 coupled to the first set of wheels 104, and the second differential 126 is drivingly coupled to a second set of axle shafts 128 coupled to the second set of wheels 114. It may be appreciated that each of the first set of axle shafts 118 and the second set of axle shafts 128 may be positioned in a housing. The first driveshaft 113 and second driveshaft 122 may be positioned to extend in parallel with the longitudinal axis 130. For an example of a configuration of vehicle 100, the second driveshaft 122 may be centered about the longitudinal axis 130.

The first differential 116 may supply a FWD in some capacity to vehicle 100, as part of rotary power transferred via the first driveshaft 113. Likewise, the second differential 126 may supply a RWD to vehicle 100, as part of the rotary power transferred via the second driveshaft 122. The first differential 116 and the second differential 126 may supply a FWD and RWD, respectively, as part of an AWD mode for vehicle 100.

The first set of wheels 104 may be fastened to and drivingly coupled to the first axle assembly 102 via a plurality of first wheel hub assemblies 146. As an example the first wheel hub assemblies 146 may be fastened to the first set of wheels 104 and a plurality of first hubs 142, wherein the first hubs 142 and fasteners of the first wheel hub assemblies 146 rotatably couple the first set of wheels 104 to the first set of axle shafts 118.

The second set of wheels 114 may be fastened to and drivingly coupled to the second axle assembly 112 via a plurality of second wheel hub assemblies 148. As an example the second wheel hub assemblies 148 may be fastened to the second set of wheels 114 and a plurality of second hubs 144, wherein the second hubs 144 and fasteners of the second wheel hub assemblies 148 rotatably couple the second set of wheels 114 to the second set of axle shafts 128.

In some examples, additionally or alternatively, the vehicle 100 may be a hybrid vehicle including both an engine an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

In some embodiments, additionally or alternatively, the transmission 108 may be a first transmission, further comprising a second transmission arranged on the second set of axle shafts 128. Herein, the transmission 108 may be interchangeably referred to as a gearbox.

A set of reference axes 201 are provided for comparison between views shown in FIGS. 2-7. The reference axes 201 indicate a y-axis, an x-axis, and a z-axis. In one example, the z-axis may be parallel with a direction of gravity and the x-y plane may be parallel with a horizontal plane that a hub assembly 310 and components that may comprise hub assembly 310 may rest upon. For this example, the z-axis may be a vertical axis, wherein the z-axis may be parallel with a vertical direction. For this example, the y-axis may be a longitudinal axis and the x-axis may be a lateral axis relative to the hub assembly 310. The x-axis may also be parallel with a central axis that rotational elements of the hub assembly 310 may rotate and spin about. The x-axis may be parallel with a shaft that may be received by the hub assembly 310. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

Turning to FIG. 2, it shows a first view 200 of hub 210 for a wheel. The hub 210 may a first side 204 and a second side 206. The hub 210 may an embodiment of the first hubs 142 or second hubs 144 of vehicle 100, of FIG. 1. The first side 204 may be a wheel side, wherein the first side 204 may face and be positioned closest to a wheel of a vehicle, such as a wheel the first set of wheels 104 or the second set of wheels 114 of FIG. 1. The second side 206 may be an axle side, wherein the second side 206 may face and be positioned closest to an axle shaft of a vehicle, such as an axle shaft of the first set of axle shafts 118 or second set of axle shafts 128 of FIG. 1. The hub 210 may be centered about an axis 208. The axis 208 may be central axis of and a rotational axis for the hub 210. The axis 208 may be central axis of and a rotational axis for the rotational elements housed by the hub 210. The hub 210 is an example of a hub assembly of prior art, wherein the hub 210 does not have a channel that extends through the material comprising the hub 210 and complementary port on the first side 204 for the use of transporting lubricant, such as grease, to bearings and rotational elements housed by the hub.

The hub 210 may comprise a plurality of mounting components 212 about a hub housing 214. The hub housing 214 may house a shaft, such as an axle shaft, and at least a bearing that supports the shaft for the hub 210. Additionally or alternatively the hub housing 214 may house a plurality of bearings and/or bushings which may support the shaft or other rotational elements of the hub 210. The mounting components 212 may fasten and drivingly couple to a steering knuckle, spindle, or another component of the wheel. The hub housing 214 has a receiving hole 216. The receiving hole 216 may be positioned about the shaft housed the hub 210 may be positioned about and rotationally coupled to. The shaft may be used with the hub 210 to drive a wheel. The hole 216 may be centered about the axis 208. The receiving hole 216 may be a through hole that may be part of a passage extending through the mounting component 212 and the hub housing 214. A mouth 218 may be located about the receiving hole 216. The mouth 218 and receiving hole 216 may be positioned radially about the axis 208. The mounting component 212 may fasten and drivingly couple to a steering knuckle, spindle, or another component of the wheel.

The mounting components 212 may be joined to or be cast from the material of the hub housing 214. The mounting components 212 may be positioned radially about the hub housing 214 at a first surface 220. The first surface 220 may comprise radial perimeter of the hub housing 214. The mounting components 212 may be flush with and contiguous with a second surface 222. The mounting component 212 may also be continuous with the surface 222. The second surface 222 may be approximately flat and normal to the axis 208. Extending in a direction parallel with the axis 208 from the second surface 222 is a platform section 224.

A plurality of holes 232 may extend through the mounting components 212. The holes 232 may receive fasteners that may be used to mount the mounting components 212 and by extension the hub 210 to a wheel. The holes 232 may be perpendicular to the surface 222 and parallel with the axis 208.

The platform section 224 may comprise a plurality of surfaces 236. The surfaces 236 may be geometric in shape, with a curved edge and a plurality of polynomial edges. The curved edge of the surfaces 236 may be contiguous with the surface 222. The polynomial edges of the surfaces 236 may join to or comprise the edges of a face 238. The platform section 224 may terminate at the face 238. The face 238 may be perpendicular to the axis 208. The face 238 extend in a radial direction from the mouth 218. The face 238 may be a distance 242 from the second surface 222.

Turning to FIG. 3, it shows a second view 300 of a hub assembly 310 for a wheel. The hub assembly 310 may be mounted in or to components of a vehicle, such as vehicle 100 of FIG. 1. The hub assembly 310 may be centered about an axis 304. The axis 304 may be a lateral axis, wherein the axis 304 may be lateral with respect to the longitudinal axis of a vehicle, such as the longitudinal axis 130 of vehicle 100 of FIG. 1. The hub assembly 310 may have a first side 306 and a second side 308, wherein the first side 306 is opposite to the second side 308. The first and second sides 306, 308 of the hub assembly 310 may be on opposite sides of a plane 309. The first side 306 may be a wheel side that is closest to and facing a wheel that hub assembly 310 may drivingly couple to. To drivingly couple to the wheel, the hub assembly 310 may rigidly couple to the wheel. For an example, the wheel may be a wheel of the first set of wheels 104 or the second set of wheels 114 of FIG. 1. The second side 308 may be an axle side that is closest to and facing an axle shaft, that the hub assembly 310 may drivingly couple to. To drivingly couple to the axle shaft, a shaft that is the axle shaft or is drivingly coupled to the axle shaft via a joint may rigidly couple the hub assembly 310. For example, the axle shaft may be an axle shaft of the first set or second set of axle shafts 118, 128 of FIG. 1. The axis 304 may be central axis of the hub assembly 310 and may be the rotational axis for the rotational elements, such as bearings, housed by the hub assembly 310. The hub assembly 310 may comprise a brake rotor 316 and a hub 318. Components of the hub assembly 310 may be drivingly coupled or support rotational elements, such as a wheel and or the shafts of an axle. Both the brake rotor 316 and the hub 318 may be positioned radially about the axis 304. The hub 318 may be positioned about a shaft 322. The shaft 322 may be centered about the axis 304. A braking system may comprise brake rotor 316, and the brake rotor 316 may be complementary to a braking component, such as a brake shoe or a brake pad. The hub 318 may be fastened and drivingly coupled to a wheel and a hub cap. Likewise the hub 318 may be drivingly coupled to an axle shaft that may supply torque to the hub 318. Shaft 322 may be an axle shaft and may drivingly couple to the hub 318. Alternatively, the shaft 322 may be a separate shaft from an axle shaft coupled such as to be driven by the axle shaft.

The shaft 322 may be drivingly coupled to one or more rotational elements of a vehicle, and more specifically an axle assembly, such as a rotational element of the first axle assembly 102 or the second axle assembly 112 of vehicle 100 of FIG. 1. Said in another way, a rotational element of the axle assembly may drive the shaft 322 when rotated via rotational energy, such as via a torque. For example, the shaft 322 may be drivingly coupled to and be driven by an axle shaft, such as via an axle shaft of the first set of axle shafts 118 or the second set of axle shafts 128 of FIG. 1. For this or another example, the rotational element or elements may rigidly couple the shaft 322. For this or another example, the rotational element or elements may drivingly couple the shaft 322 via a joint. Alternatively, it is to be appreciated that a rotational element of the vehicle such as an axle shaft of the first set of axle shafts 118 or the second set of axle shafts 128 may comprise the shaft 322.

The hub 318 may comprise a platform section 324. The platform section 324 may rise from a surface (e.g., a surface 534 of FIG. 5) of the hub 318 and extend an axial direction with the axis 304. The hub 318 may house and may be located at least partially about bearings.

Visible in the second view 300, the housing component may comprise a receiving hole 336. The receiving hole 336 may be positioned radially about the shaft 322, and the shaft 322 may extend and be passed through the receiving hole. A socket 334 may be positioned about the receiving hole 336. Likewise, a first mouth 332 may be fluidly coupled to the receiving hole 336 and may be an opening through which the shaft may be passed into the receiving hole 336. The shaft may be drivingly coupled to the hub 318 via the receiving hole 336 and socket 334. The first mouth 332 to the receiving hole 336 may house and support a bearing that may support the shaft 322. The mouth may support a single or plurality of seals, that may fluidic seal the first mouth 332. The seal may prevent work fluid, such as oil or grease, from leaving the receiving hole 336 via the first mouth 332. The first mouth 332 may be the location where a cover may be mounted. The cover may be a device, such as a dust cap, that prevents particulates from entering the first mouth 332. The cover when coupled to the first mouth 332 may prevent components housed by the first mouth 332 from becoming dislodged or removed. The cover may overlap and have surface sharing contact with surfaces of the mouth and a face 338 positioned about the mouth. The face 338 is surface that may be an interface and a flange for the cover. The face 338 may be on and face the first side 306. The face 338 may be hexagonal in shape.

The hub 318 may have a plurality of first platforms 344. The first platforms 344 may be positioned radially about the platform section 324 and the perimeter of the hub 318. Each of the first platforms 344 may be equidistant from one another. The first platforms 344 may have a plurality of first surfaces 342. For example, each of the platforms 344 may have at least one of the first surfaces 342. The first surfaces 342 may face and be on the first side 306 of the hub assembly 310. For an example embodiment, there may be four of the first platforms 344. The first platforms 344 have a plurality of through holes 346, wherein each of the first platforms 344 is complementary to at least one of the through holes 346. The through holes 346 may be complementary to a plurality of fasteners 348, wherein each of the through holes 346 may be fit to a fastener of the fasteners 348. For an example embodiment, the fasteners 348 may have a threading that is complementary to the through holes 346. The fasteners 348 may be threaded through the through holes 346. The fasteners 348 may be complementary holes of a component or features of a wheel that the hub 318 may be mounted to, such as a lug and/or a hub cap. When mounted via the fasteners 348, the hub 318 may be drivingly coupled the wheel. More specifically, when fastened and mounted via the fasteners 348, the fasteners 348 may rigidly couple the hub 318 to the wheel. The fasteners 348 may also be complementary to additional fastening components, such as lug nuts, that may be used to fasten the fasteners 348 to a wheel and/or a hubcap.

Turning to FIG. 4, it shows a third view 400 of the hub 318. The hub 318 may be isolated from other components of the hub assembly 310 of FIG. 3. The hub 318 may also be centered about the axis 304, such that the socket 334 and receiving hole 336 may be positioned approximately radially about the axis 304.

The hub 318 may have a first side 406 and a second side 408, wherein the first side 406 is opposite to the second side 408. The first side 406 may be a wheel side, wherein the first side 406 may be closer to a wheel that the hub 318 may drivingly couple to compared than the second side 408. As a wheel side, the first side 406 may face the wheel the hub 318 couples to. The second side 408 may be an axle side, wherein the second side 408 may be closer to an axle the hub 318 may drivingly couple to compared to the first side 406. As an axle side, the second side 408 may face the axle shaft the hub 318 couples to. The first side 306 of FIG. 3 may comprise the first side 406. The second side 308 of FIG. 3 may comprise the second side 408.

The hub 318 may comprise a bearing groove 430 located about the socket 334. A plurality of walls 426 and a plurality of mounting structures 428 are positioned radially, such as with respect to the axis 304, about the groove 430. The groove 430 may be a first groove of a plurality of grooves that the second side 408 of the hub 310 includes. The hub 310 may comprise the plurality of walls 426, and the plurality of walls 426 may comprise the material of the hub 318. The mounting structures may be joined to or be cast with the hub 318 as to be contiguous the groove 430 and the walls 426. The plurality of walls 426 may comprise a portion of an outer perimeter 431 of the groove 430. Likewise, the mounting structures 428 may comprise a portion of the outer perimeter 431 of the groove 430. The socket 334 may comprise a journal region 432. The groove 430 may be located radially about the journal region 432, such as with respect to the axis 304. The journal region 432 may support and be positioned concentric to a bearing that may be housed by the groove 430. The journal region 432 and the groove 430 may be a part of and face the second side 408. The bearing housed via the groove 430 and the journal region 432 may allow spinning of the hub 318 with a rigidly coupled shaft. Further the bearing may allow for spinning of the rigidly coupled shaft and the hub 318 freely from components, such as a chassis or a body, of a vehicle housing the hub 318, such as vehicle 100 of FIG. 1. The hub 318 may spin around the axis 304.

The mounting structures 428 may comprise the through holes 346. There may be one of the through holes 346 for each of the mounting structures 428. The through holes 346 extend between and are normal to the first platforms 344 and the second platforms 438.

The groove 430 may comprise a first valley 434 and a second valley 436. The first valley 434 and second valley 436 may be used to collect and support lubricant, such as grease, between a bearing and the groove 430. The first valley 434 and second valley 436 may alternatively be referred to herein as a first grease valley 434 and second grease valley 436, respectively. The first valley 434 may join and comprise an outer surface of the journal region 432 and a shoulder 435. The second valley 436 may join the shoulder 435 to a base 437 of the groove 430. The first valley 434 comprises the shoulder 435. The first valley 434 may extend toward and descend toward the shoulder 435 in radially direction from the journal region 432. The second valley 436 may comprise the base 437. The second valley 436 may extend and descend toward the base 437 in radially direction from the shoulder 435. The perimeter 431 may extend and ascend in a radial direction from the base 437. The shoulder 435 may support a bearing positioned about the journal region 432. The bearing supported by the shoulder 435 may fluidly seal to one or more surfaces of the first valley 434. For example, the bearing may fluidly seal to a surface of the first valley 434 comprising the shoulder 435. The fluid seal between the bearing and the first valley 434 may be liquid tight. When the bearing fluidly seals against first valley 434, fluid housed via the volume of the second valley 436 may be prevented from leaking between the bearing and surfaces of the first valley 434.

In addition to the first platforms 344, the mounting structures 428 may comprise a plurality of second platforms 438. Each of the mounting structures 428 may be complementary and comprise one of the second platforms 438. Each of the second platforms 438 are joined and/or contiguous with a first platform of the first platforms 344. There may be as many of the second platforms 438 as the first platforms 344. Each of the second platforms 438 may be positioned equidistant from the groove 430. The plurality of walls 426 may be positioned between each of the mounting structures 428. The plurality of walls 426 may be rounded in shape and curve with the curvature of the groove 430.

The receiving hole 336 may have a second mouth 440. The second mouth 440 may receive a shaft; such as shaft 322 of FIG. 3. The receiving hole 336 may have a plurality of splines 442 visible via the second mouth 440. The journal region 432 comprises an outer surface 444 and an inner surface 446. The splines 442 may be joined or comprise the material of the socket 334. The splines 442 may be joined to or comprise the material of a portion of the inner surface 446. A portion of the splines may be joined to portions of the journal region 432 located about the receiving hole 336. The splines 442 may have a length that extends in parallel with the axis 304. Likewise, the splines 442 may be positioned radially about the axis 304. The splines 442 may be complementary to the shaft. When the shaft is meshed with the splines 442, the shaft may drivingly couple to the hub 318. The first valley 434 may comprise the outer surface 444 and the shoulder 435.

The first platforms 344 may comprise a plurality of first walls 450. The second platforms 438 may comprise a plurality of second walls 452. The second platforms 438 may also comprise a plurality of second surfaces 448. There may be at least one of the second surfaces 448 for each of the second platforms 438. The second surfaces 448 may face and be part of the second side 408. The second surfaces 448 may be flush with and contiguous with a plurality of rims 449 of the walls 426. The surfaces of the rims 449 may extend radially and curve around the groove 430. The second platforms 438 may abut a breaking feature or component, such as the brake rotor 316 of FIG. 3. More specifically, the second surfaces 448 may have surface sharing contact with a surface or plurality of surfaces of the braking feature or component, such as a surface of the brake rotor 316.

The first platforms 344 and the second platforms 438 may be contiguous via a plurality of first chamfers 454, wherein each of the first platforms 344 may be contiguous with one of the second platforms 438 via one of the first chamfers 454. The first platforms 344 may be contiguous with the walls 426 via a plurality of second chamfers 456. For example, some of the first walls 450 may be connected to and contiguous with the walls 426 via the second chamfers 456, wherein one of the first walls 450 may be connected to and contiguous with one of the walls 426 via one of the second chamfers 456. Likewise, the second platforms 438 may be contiguous with the walls 426 via a plurality of third chamfers 458. For example, some of the second walls 452 may be connected to and contiguous with some of the walls 426 via the third chamfers 458, wherein one of the second walls 452 may be connected to and contiguous with one of the walls 426 via one of the third chamfers 458. The first walls 450 may be connected to and continuous with one another via a plurality of first edges 460. The second walls 452 may be connected to and continuous with one another via a plurality of second edges 461. For an example embodiment, each of the first platforms 344 may have four of the first walls 450 and three of the first edges 460. Likewise, each of the second platforms 438 may have four of the second walls 452 and two of the second edges 461.

Located on the surfaces of the first valley 434 is a first port 462. The port may be positioned on an incline between the outer surface 444 and the shoulder 435. The first port 462 may fluidly couple to at least an inner passage of the hub 318. The first port 462 may be inset into a groove 464. The groove 464 may be inset into portions of the first valley 434, such as the outer surface 444 and the shoulder 435. The groove 464 may be a second groove of the second side 408 of the hub 318. Lubricant, such as grease, may enter the groove 430 via the first port 462. The lubricant from the first port 462 may coat the first valley 434, the second valley 436, the outer surface 444 of the journal region 432 such that friction may be reduced between a bearing of the groove 430 and the aforementioned features. In particular lubricant from the first port 462 may coat the shoulder 435 as to prevent friction between the shoulder 435 and the bearing. Likewise, the groove 464 may force lubricant in a direction parallel with the axis 304 to coat the outer surface 444 of the journal region 432 above or at the top of the first valley, with respect to the y-axis.

The hub 318 and the features therein may be used in place of a bearing installation tool to install bearing, such that the bearing is housed via the groove 430. Said in another way, the bearing that may be housed via the groove 430 may be installable via one or more features of the hub 318 absent a separate bearing installation tool. When installed, the bearing is positioned to be greased or lubricated via the first port 462. The groove 430 comprises one or more installation features used to install the bearing. For example, the first valley 434 and the journal region 432 may guide the bearing to rest upon the shoulder 435. The valley 434, journal region 432, and the shoulder 435 may keep the bearing centered radially around the axis 304 as the hub 318 is fastened and rigidly coupled to the wheel and/or wheel hub.

Turning to FIG. 5, it shows a fourth view 500 of the hub 318. The hub 318 may be isolated from other components of the hub assembly 310 of FIG. 3. The hub 318 may also be centered about the axis 304, such that the socket 334 and receiving hole 336 may be positioned approximately radially about the axis 304.

The platform section 324 extends a distance in parallel to the central axis of from a surface 534 of the hub 318. The surface 534 may be flush with and contiguous with the surfaces 342 of the first platforms 344 of FIG. 3. The surface 534 may also be continuous with and comprise the surfaces 342. The distance 536 may be normal to the surface 534 and may be parallel with the axis 304.

Turning to FIG. 6, it shows a fifth view 600 of the hub 318. The hub 318 may be isolated from other components of the hub assembly 310 of FIG. 3. The hub 318 may also be centered about the axis 304, such that the socket 334 and receiving hole 336 may be positioned approximately radially about the axis 304. The fifth view 600 is a side view showing the hub 318 from the first side 406. A Line A-A 602 may divide the hub 318 into two symmetrical halves. The line A-A 602 may be perpendicular to the axis 304.

The fifth view 600 shows the platform section 532 may have a plurality of surfaces 632. The surfaces 632 may be positioned radially about the face 338, with respect to the axis 304. The surfaces 632 may be geometric in shape, with a first portion (e.g., a polygonal portion) joining the face 338 and a second portion (e.g., a parabolic curving portion) joining the surface 534 of FIG. 5 and/or the surfaces 342. The first portion may be referred to alternatively as a polygonal portion for being a polygonal shape, with a plurality of straight edges arranged in a partial polygon defining a portion of a perimeter. The second portion may be referred to alternatively as a parabolic curving portion for having a shape defined by a parabolic curve, where the second portion has a continuous curve defining another portion of a perimeter. The surfaces 632 may therein be contiguous with the face 338, and the face 338 may be a common face that all the surfaces 632 are contiguous with therein. The surfaces 632 may extend downward with respect to the axis 304 toward the face 338.

The fifth view 600 also shows a second port 652 depressed into the platform section 532. For an example of an embodiment the second port 652 may be located and depressed into one of the surfaces 632. A counter hole 654 may be located about the second port 652 and depressed into the one of the surfaces 632. The counter hole 654 and second port 652 may be divided into symmetrical halves by the line A-A 602. The second port 652 may be a port where lubricant, such as grease, may be injected to lubricate the groove 430 of FIG. 4. Lubricant injected into the second port 652 may be used to lubricate and coat the first valley 434, second valley 436, outer surface of the journal region 432, and the shoulder 435. Additionally, a plurality of components 662 may be inset into some of the surfaces 632.

Turning to FIG. 7, it shows a sixth view 700 of the hub 318. The sixth view 700 may be a cut, such as a cross section, taken on line A-A 602 of FIG. 6. The sixth view 700 shows internal components, volumes, and other features of the hub 318.

The sixth view 700 shows a first counter hole 722 located between the first mouth 332 and the socket 334. The first counter hole 722 may be a counter bore. The first counter hole 722 may comprise a flat surface that may extend radially from and comprise a base of the socket 334. Likewise, between the second mouth 440 and splines 442, is a second counter hole 724. The second counter hole 724 may be counter bore. Alternatively, there may be a countersink in place of the second counter hole 724. The first counter hole 722 may comprise an expanded region 726. The expanded region 726 may be a cut such as an undercut. The expanded region may 726 be used to house components, such as a seal and/or a separator. The seal and/or separator may be positioned about or before a shaft or other rotational elements, such that the mouth may be fluidly sealed from work fluid, such as grease or other lubricants. Additionally, components, such as a bearing, may also be housed in the expanded region 726.

The first mouth 332 may be of a first diameter 730 and a third diameter 734, wherein the first diameter 730 is a maximum diameter and the third diameter 734 is a minimum diameter. The first counter hole 722 and the expanded region 726 may be of a second diameter 732. The second diameter 732 may be a maximum diameter and the third diameter 734 may be a minimum diameter for the first counter hole 722 and the expanded region 726. The receiving hole 336 may be a fourth diameter 736. The second counter hole 724 may be a fifth diameter 738. The first diameter 730 may be greater than the second diameter 732, the third diameter 734, the fourth diameter 736, and the fifth diameter 738. Likewise, the second diameter 732 may be greater than the third diameter 734, the fourth diameter 736, and the fifth diameter 738. The third diameter 734 may be greater than the fourth diameter 736 and the fifth diameter 738. The fifth diameter 738 may be greater than the fourth diameter 736.

The hub 318 has a channel 742. The channel 742 is internal to and extends through the material of the hub 318. The channel 742 is positioned between the first port 462 and the second port 652, such that the channel 742 may fluidly couple the first port 462 and the second port 652. Said in another way, the channel 742 may place the first port 462 in fluid communication with the second port 1154.

Inner surfaces of the second port 652 may have a threading 748. The threading 748 may be a zerk threading. The threading 748 may be complementary to the threading of a port for a greasing tool, another grease dispenser, or another fluid dispenser. Said in another way, a feature of the fluid dispenser may thread or mesh with the threading 748, and the fluid dispenser may fluidly couple to the second port 652, allowing for grease or other lubricant to be extruded into the second port 652 from the dispenser. Components and features of the greasing tool, grease dispenser, or fluid dispenser that may mesh with the threading may include one or more nozzles.

Fluid, such as grease or another form of lubricant, may enter the channel 742 via the second port 652. The work fluid may travel from the second port 652 to the first port 462 via the channel 742. Work fluid may then exit the channel 742 via the first port 462. Work fluid may flow from the first port 462 into the groove 464 and onto the shoulder 435, to coat the first valley 434 and the second valley 436, and other portions of the journal region 432. The channel 742 may be sixth diameter 752. The second port 652, channel 742, and the first port 462 may allow lubricant, such as grease, to be applied to the groove 430 from the first side 406. The positioning of the first port 462 and the groove 464 may allow for lubricant to coat the surfaces of the bearing using lubricant supplied via the first port 462 and the channel 742. Applying lubricant from the first side 406 via the first port 462 and channel 742, may allow the groove 430 to have lubricant applied while the hub 318 is fastened to components of a wheel. Likewise, applying lubricant from the first side 406 via the first port 462 and channel 742, may allow the groove 430 to have lubricant applied while the groove 430 is enclosed by the hub 318 and components of the wheel the hub 318.

The hub 318 may remain physically coupled and rigidly coupled to a wheel, a wheel hub or another component of the vehicle while lubricant is applied to the groove 430 via being fed through the second port 652. The first port 462, the second port 652, and the channel 742 therein allow application of grease or other lubricant to one or more components housed by the groove 430, such as the bearing, without disassembly of the hub 318 or decoupling of the hub 318 from other components of the vehicle.

Turning to FIG. 8, it shows a seventh view 800. The seventh view 800 is a sectional view of the first region 712 isolated from other features and components of the hub 318. The seventh view 800 shows additional features of the counter hole 654, the second port 652, the channel 742, and the first port 462.

A grease region 822 may comprise a portion of the second port 652. The grease region 822 may be a region wherein a greasing tool may seal against and fluidly couple to the second port 652. The grease region 822 and second port 652 may comprise a first countersink 832. The second port 652 may also comprise a second countersink 834. The second countersink 834 may be positioned between the first countersink 832 and the channel 742.

The channel 742 may include a sink 836. The sink 836 may be located at an end of the channel 742 nearest to the first port 462. The sink 836 may have a conical surface that may curve about a centerline of the channel 742. The surface of the sink 836 may encircle, decrease in diameter toward, and terminate at the centerline of the channel 742. The sink 836 may prevent over pressurization and blockage of lubricant being extruded through the channel 742 and the first port 462.

The counter hole 654 may be of a seventh diameter 842. The second port 652 may be of an eighth diameter 844. The first port 462 may be of a ninth diameter 846. The seventh diameter 842 may be greater than the eighth diameter 844, the sixth diameter 752, and the ninth diameter 846. The eighth diameter 844 may be greater than the sixth diameter 752 and the ninth diameter 846. The sixth diameter 752 may be greater than the ninth diameter 846.

In this way, grease may be applied to a bearing of a wheel hub without disassembling the wheel hub from a wheel hub assembly and other components, such as a shaft and a wheel, the wheel hub may be drivingly coupled to. Lubricant may be applied via a port in the wheel side of the hub. The port in the wheel side of the hub may have threading compatible with (e.g., be threaded with) nozzles and other grease dispensing features to fluidly couple with common grease application tools. The threading may be a zerk threading.

Turning to FIG. 9, it shows an eighth view 900 of a bearing carrier 910. The eighth view 900 may be a side view of the bearing carrier 910. The bearing carrier 910 is a separate component from a wheel hub, such as the hub 318 of FIGS. 3-8, that carriers a bearing to support a shaft. For example, the bearing carrier 910 may be knuckle, such as an axle knuckle. For this or another example, the bearing carrier 910 may be a spindle, such as an axle spindle.

The bearing carrier 910 may have a first side 904 and a second side 906. The first side 904 may be wheel side that may face and be positioned closest to the wheels of a vehicle, such as a wheel the first set of wheels 104 or the second set of wheels 114 of FIG. 1. The second side 906 may be an axle side that may face and be positioned closest to a shaft of an axle of a vehicle, such as a shaft of the first set of axle shafts 118 or second set of axle shafts 128 of FIG. 1. The bearing carrier 910 may be centered about an axis 908. The axis 908 may be central axis of and a rotational axis for bearing carrier 910. The axis 908 may be central axis of and a rotational axis for the rotational elements housed by the bearing carrier 910. The bearing carrier 910 may be an additional configuration of a hub. As a hub, the bearing carrier 910 may be complementary and rotationally coupled to a wheel of a vehicle, such as a wheel of the first set of wheels 104 or the second set of wheels 114. The bearing housed by the bearing carrier 910 may contact and support a shaft, centering the shaft around the axis 908. When the shaft is supported by the bearing, the bearing may allow for the spinning of the shaft around the axis 908, wherein the shaft spins freely of the bearing carrier 910.

The bearing carrier 910 may comprise a receiving hole 920. The bearing carrier 910 may comprise a socket section 922 and a mounting section 924. The socket section 922 may comprise the receiving hole 920. The socket section 922 may be positioned about the receiving hole 920, such as radially around the receiving hole 920. The mounting section 924 may be positioned about and comprise a cavity 926. More specifically, the mounting section 924 may be positioned radially around the cavity 926, defining the shape and volume of the cavity 926, therein. The socket section 922 may be cylindrical in shape. The mounting section 924 may have a core that is cylindrical in shape. The receiving hole 920 and the cavity 926 may be volumetrically continuous. An object that may be extended through the receiving hole 920 may therein be extended through the cavity 926 from the receiving hole 920, and vice versa.

The core of the mounting section 924 may comprise a first surface 938 and a second surface 940. The mounting section 924 may comprise a first appendage 932, a second appendage 934, and a third appendage 936. The first surface 938 may be an outer surface radially about and forming a perimeter of the core of the mounting section 924. The axis 908 may be normal to the second surface 940, and the second surface 940 may face and be located nearest to the second side 906. The first appendage 932 may extend at an angle 942 from the second surface 940. The second and third appendages 934, 936 may extend in a radial direction with respect to the first surface 938. A first mount 946 and a second mount 948 may be joined to or be comprised by the core of the mounting section 924. The first mount 946 and second mount 948 may each have a length parallel with the axis 908. Likewise, the first mount 946 and second mount 948 may each have a width radial with respect to the axis 908. The second appendage 934 may have the same dimensions and features as the third appendage 936 mirrored over the axis 908. The first mount 946 may have the same dimensions as the second mount 948 mirrored over and with respect to the axis 908.

A valley 952 may be comprised by the core of the mounting section 924. The valley 952 may be continuous and terminate at a countersink 954. The valley 952 and the countersink 954 may each be an inner surface of the mounting section 924. The countersink 954 may be a surface positioned radially about the receiving hole 920 with respect to the axis 908. The valley 952 and the countersink 954 may define the volume of the cavity 926. The valley 952 may be a grease valley that lubricant, such as grease, may accumulate against to lubricate the rotational elements of the bearing housed in the cavity 926.

Lubricant may be passed to the valley 952, the cavity 926, and the receiving hole 920 via a first port 956. A counter hole 958 may be continuous with and extend about the first port 956. The first port 956 and counter hole 958 may extend through the material of the core of the mounting section 924 at the second surface 940. The first port 956 and counter hole 958 may have volumes that extend normal to the second surface 940. Said in another way, the first port 956 and counter hole 958 may be inset and recessed into the second surface 940. The first port 956 and counter hole 958 may be positioned at the second surface 940 between the second appendage 934 and the third appendage 936.

Inner surfaces of the first port 956 may have threading. The threading may be a zerk threading. The threading may be complementary to the threading of a port for a greasing tool, another grease dispenser, or another fluid dispenser. Said in another way, a feature of the fluid dispenser may thread or mesh with the threading, and the fluid dispenser may fluidly couple to the first port 956, allowing for grease or other lubricant to be extruded into the first port 956 from the dispenser. Components and features of the greasing tool, grease dispenser, or fluid dispenser that may mesh with the threading may include one or more nozzles.

The first appendage 932 may comprise a first hole 972. The second appendage 934 may comprise a second hole 974. The third appendage 936 may comprise a third hole 976. Each of the first hole 972, the second hole 974, and the third hole 976 may be holes complementary to a fastener. Each complementary fastener to the first hole 972, the second hole 974, and the third hole 976 may be used to mount the bearing carrier 910 to a component or feature of the vehicle.

Likewise, the first mount 946 may comprise a fourth hole 982 and a fifth hole 984, and the second mount 948 may comprise a sixth hole 986 and a seventh hole 988.

The first mount 946 may have first outer surface 992 and a first inner surface 994. Likewise, the second mount 948 may have a second outer surface 996 and a second inner surface 998. The first inner surface 994 and the second inner surface 998 may each have a curvature, such that the first inner surface 994 and the second inner surface 998 may be flush with a curvature of an inner perimeter of the second surface 940. Likewise, the first inner surface 994 and the second inner surface 998 may each have a curvature, such that the first inner surface 994 and the second inner surface 998 may be flush with the curvature of the valley 952.

Turning to FIG. 10, it shows a ninth view 1000 of a bearing carrier 910. The ninth view 1000 is a side view of the bearing carrier 910. The ninth view 1000 may be taken from the second side 906 of FIG. 9. The ninth view 1000 shows a second line in the form of a line B-B 1010 may divide the bearing carrier. The line B-B 1010 may be perpendicular to the axis 908. The line B-B 1010 may also be approximately parallel with the z-axis of the reference axes 201.

The ninth view 1000 also shows the first mount 946 and the second mount 948 may each comprise a first groove 1052 and a second groove 1054, respectively. The first groove 1052 may depress through the material of the first mount 946 in a direction parallel with the axis 908 to be continuous with and open to the fourth hole 982 of FIG. 9. Likewise, the second groove 1054 may depress through the material of the first mount 946 in a direction parallel with the axis 908 to be continuous with the sixth hole 986. The first groove 1052 may have a first length 1056. The second groove 1054 may have a second length 1058. The first and second lengths 1056, 1058 may be perpendicular to the axis 908. The first length 1056 may extend from the first outer surface 992 to the first inner surface 994. The second length 1058 may extend from the second outer surface 996 to the second inner surface 998.

Turning to FIG. 11, it shows a tenth view 1100 of a bearing carrier 910. The tenth view 1100 is a sectional view of the bearing carrier 910 that may be taken on the line B-B 1010 of FIG. 10.

The tenth view 1100 shows the receiving hole 920 may have a first mouth 1122 and a second mouth 1124. The first mouth 1122 may be positioned on the first side 904. The second mouth 1124 may be positioned closer to the second side 906. The second mouth 1124 may be contiguous with the countersink 954. Between the first mouth 1122 and the second mouth 1124 are a first groove 1126 and a second groove 1128. The first groove 1126 and second groove 1128 may have volumes that extend radially into an inner surface 1130 of the receiving hole 920. The inner surface 1130 may be positioned about the axis 908. The inner surface 1130 may be cylindrical in shape and may be positioned radially about the axis 908.

A bearing or a plurality of bearings may be housed by the receiving hole 920. The inner surface 1130 may be positioned about the bearing or the plurality of bearings. The bearing or plurality of bearings may be positioned between the first mouth 1122 and second mouth 1124 along the axis 908. The first groove 1126 may be a lubrication groove, such as a greasing groove. As a lubrication groove, the first groove 1126 may accumulate and spread a lubricant, such as grease, about the receiving hole 920. Lubricant accumulated and spread about the receiving hole 920 by the first groove 1126, may lubricate the bearing or bearings housed by the receiving hole 920. The second groove 1128 may be a groove for a fastener, such as retainer ring, such as a snap ring. The fastener may retain the bearing to the receiving hole 920. Additionally or alternatively, the second groove 1128 may be a groove for a seal, such as an o-ring, that may create a fluid seal between the inner surface 1130 and the seal therein. The fluid seal may prevent leakage of grease or lubricant between the surface 1130 and the seal therein.

The socket section 922 may comprise components or features of plurality of diameters, such as a first diameter 1132, a second diameter 1134, a third diameter 1136, a fourth diameter 1138, and a fifth diameter 1140. The first mouth 1122 may be of the first diameter 1132. The section of the receiving hole 920 bounded by the inner surface 1130 may be of the second diameter 1134. The first groove 1126 may be of the third diameter 1136. The second groove 1128 may be of the fourth diameter 1138. The second mouth 1124 may be of the fifth diameter 1140. The third diameter 1136 and the fourth diameter 1138 may be greater in distance than the first diameter 1132, the second diameter 1134, and the fifth diameter 1140. The second diameter 1134 may be greater in distance than the first diameter 1132 or fifth diameter 1140. For an example, the fourth diameter 1138 may be a greater distance than the third diameter 1136. For this or another example, the first diameter 1132 and the fifth diameter 1140 may be approximately the same distance. The cavity 926 may be of a sixth diameter 1142. The sixth diameter 1142 may be variable, such that the sixth diameter 1142 may decrease with the valley 952 and countersink 954 closer to the second mouth 1124 along the axis 908. At a minimum distance, the sixth diameter 1142 may be approximately the same distance as the fifth diameter 1140.

The first groove 1126 may be fluidly coupled to the first port 956 via a channel 1152 and a second port 1154. The second port 1154 may be inset into the first groove 1126 and the surface 1130. The channel 1152 may extend through the material of the bearing carrier 910, such as through the material of the mounting section 924 and the socket section 922. The channel 1152 may fluidly couple and be continuous with the first port 956 and second port 1154. Said in another way, the channel 1152 may place the first port 956 in fluid communication with the second port 1154. Lubricant may enter the channel 1152 via the first port 956. Lubricant may exit the channel 1152 via the second port 1154. Lubricant may enter, coat, and accumulate about the first groove 1126 via the second port 1154. The lubricant may be extruded or fed through the first port 956 to the second port 1154 via the channel 1152, while the bearing carrier 910 remains assembled and physically couples one or more other components of a vehicle, such as one or more components of vehicle 100 of FIG. 1. For example, the bearing carrier 910 may be mounted or physically coupled to a component of a chassis or an axle assembly of the vehicle while lubricant is applied to the first groove 1126 via being fed through the first port 956. The first port 956, the second port 1154, and the channel 1152 therein allow application of lubrication to one or more components housed by the receiving hole 920, such as the bearing or bearings.

In this way, grease may be applied to a bearing of knuckle or spindle without disassembling the knuckle or spindle. Additionally, grease may be applied to the bearing of the knuckle or spindle without decoupling the knuckle or spindle from a wheel hub assembly and other components, such as a shaft and a wheel. Lubricant may be applied via a port in the wheel side of the knuckle or spindle. The port in the wheel side of the knuckle or spindle may have threading that may be threaded with features of a nozzles or other grease dispensing features to fluidly couple with common grease application tools. The threading may be a zerk threading.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to powertrains that include different types of propulsion sources including different types of prime movers, internal combustion engines, and/or transmissions. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A component for a wheel hub assembly and an axle assembly comprising:
a volume;
a channel, the channel extending from a first side of the component to the volume;
a first port, placing the channel in fluid communication with the volume; and
a second port, placing the channel in fluid communication with a surface of the first side;
wherein the component houses a bearing via the volume, and lubricant is applied to the volume and the bearing via the channel while the component remains assembled and physically coupled to other components of a vehicle.

2. The component of claim 1, wherein the component is a wheel hub.

3. The component of claim 1, wherein the component is a knuckle.

4. The component of claim 1, wherein the bearing supports a shaft that is drivingly coupled to a rotational element of the axle assembly, wherein one or more components of the axle assembly drive the shaft.

5. The component of claim 4, wherein the first side is a wheel side, the wheel side positioned closest to a wheel that the shaft is drivingly coupled to, wherein the shaft drives the wheel.

6. The component of claim 1, wherein the second port fluidly couples with a greasing tool, such that the greasing tool applies a grease to the volume and the bearing via the channel, and the grease is the lubricant.

7. The component of claim 6, wherein the second port has a threading that meshes with the greasing tool.

8. The component of claim 7, wherein the threading is a zerk threading.

9. The component of claim 1, wherein the bearing is installable to the component via one or more features of the component including the volume, wherein the bearing is installable absent a separate bearing installation tool.

10. A wheel hub of a wheel hub assembly comprising:
a first groove;
a channel, the channel extending from a first side of the wheel hub to the first groove;
a first port, placing the channel in fluid communication with the first groove; and
a second port, placing the channel in fluid communication with a first surface of the first side;
wherein the wheel hub rigidly couples to a wheel having a wheel side closest to the wheel, wherein the wheel hub houses a bearing via the first groove, and lubricant is applied to the first groove and the bearing via the channel while the wheel hub remains assembled and physically coupled to other components of a vehicle.

11. The wheel hub of claim 10, wherein a journal extends from a second side opposite the first side and rigidly couples to a shaft, wherein the first groove is located around the journal, and the bearing supports the journal allowing spinning therein.

12. The wheel hub of claim 11, wherein the first side is the wheel side and the second side is an axle side, wherein the axle side is a side facing an axle that drivingly couples the shaft, wherein one or more components of the axle drive the shaft.

13. The wheel hub of claim 10, wherein the wheel hub includes a socket around a receiving hole, wherein the wheel hub is centered around the receiving hole, and a shaft extends through the receiving hole to rigidly couple the wheel hub.

14. The wheel hub of claim 10, wherein the first surface is one of a plurality of surfaces, wherein each of the surfaces have a first portion with a polygonal shape and a second portion with a parabolic curved shape.

15. The wheel hub of claim 14, wherein the first portion of each of the surfaces join to a face, the face being a common face that the surfaces are contiguous with therein.

16. The wheel hub of claim 10, wherein the first groove comprises a plurality of valleys, including a first valley and a second valley, the first valley comprising a shoulder, and the second valley extending away from the shoulder, wherein the first valley and second valley collect and house lubricant from the first port.

17. The wheel hub of claim 10, wherein the wheel hub includes mounting structures joined therein and positioned radially around the first groove, wherein the mounting structures and fasteners mount to and abut the wheel, wherein each of the mounting structures includes a first platform and a second platform, wherein the second platform has a second surface, and the second surface contacts a brake rotor.

18. The wheel hub of claim 16, where a second surface defining a shape of the first valley comprises a second groove, the second groove inset into the first valley, the first port is inset into the second groove, and the first groove surrounds the second groove.

19. A bearing carrier of a wheel hub assembly and an axle assembly comprising:
a socket section, the socket section comprising a socket and a hole;
a mounting section;
a cavity, the mounting section is positioned around the cavity and the cavity is volumetrically continuous with the hole;
a first port, the mounting section comprising the first port;
a second port, the socket section comprises the second port;
a channel, the channel extending from the first port to the second port and placing first port in fluid communication the second port; and
a bearing is housed by the socket section via the hole, wherein lubricant is applied to bearing via the first port, the second port, and the channel while the bearing carrier remains assembled and physically coupled to one or more other components of a vehicle.

20. The bearing carrier of claim 19, wherein the bearing carrier is an axle knuckle or an axle spindle.
